(19) United States
(12) Patent Application Publication
(10) Pub. No.: US 2026/0039562 A1
(43) Pub. Date: Feb. 5, 2026

(54) RADIO FREQUENCY OPTIMIZATION USING ARTIFICIAL INTELLIGENCE

(71) Applicant: T-MOBILE INNOVATIONS LLC, Overland Park, KS (US)

(72) Inventor: Sathyaraj KOLANDASAMY, Celina, TX (US)

(21) Appl. No.: 18/792,208

(22) Filed: Aug. 1, 2024

(51) Int. Cl. H04L 41/14; H04L 41/16; H04W 24/02

(52) U.S. Cl. CPC H04L 41/145; H04L 41/16; H04W 24/02

(57) ABSTRACT

At a high level, the technology disclosed herein relates to methods, systems, media, etc., for a network coverage optimization engine. In embodiments, network coverage can be optimized by applying particular updates, changes, etc., to a network configuration for one or more coverage areas provided by one or more base stations (e.g., a macro base station, another type of outdoor base station, an indoor cell, a distributed antenna system). For example, the network configuration can be determined based on one or more particular radio frequency (RF) performance metrics for a coverage area being below a threshold. In embodiments, one or more machine learning models may be implemented to predict signal coverage changes upon applying the determined network configuration based on the collected data for the coverage area (e.g., network data, user device network feedback, user device location data, environmental profiles for the coverage area, etc.).

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for radio frequency (RF) optimization using artificial intelligence (AI). In embodiments, network data (e.g., network data 132 of FIG. 1), user device network feedback (e.g., user equipment (UE) data 134 of FIG. 1), and location data (e.g., UE data 134 of FIG. 1) for user devices associated with the user device network feedback are received. In embodiments, a particular geographical coverage area can be identified based on the location data. In embodiments, an RF performance metric for the particular geographical coverage area is determined to be below a threshold based on the network data and the user device network feedback. In embodiments, a network configuration may be determined for implementation based on the RF performance metric being below the threshold.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for utilizing a network coverage optimization engine, in accordance with embodiments herein;

FIG. 2 depicts an example flow chart associated with determining and implementing a network configuration, in accordance with embodiments herein;

FIG. 3 depicts an example flowchart associated with utilizing the network coverage optimization engine, in accordance with embodiments herein; and

FIG. 4 depicts an example network coverage optimization client and corresponding functionality associated with the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, network performance and coverage monitoring with Network Operation Centers (NOCs) may involve challenges associated with network complexity and the increasing demands for reliable, high-speed connectivity. For example, a heterogeneous network may include a large number of devices (e.g., routers, switches, servers, and IoT devices) utilizing or requesting to utilize the network via one or more access points. Further, an NOC may have to process and analyze various types of data rapidly for proper issue detection. As another example, attempts at providing low latency coverage in a geographically dispersed environment may be hindered without an understanding, by the system, of that environment (e.g., without data associated with a topography of that environment).

Embodiments of the technology discussed herein provide various improvements to these challenges discussed above. For example, the technology described herein can improve upon the management of radio frequency coverage to improve network performance, improve upon user device experience, reduce network congestion, reduce latencies and packet transmission delays, and reduce performance degradations. By way of example, based on identifying particular coverage area densities and user device densities, the network coverage optimization engine can adjust one or more of an electrical tilt, a power level, a handover element, etc. associated with a network configuration. As another example, the network coverage optimization engine can adjust the electrical tilt of one or more antennas of a base station (e.g., a macro base station, an indoor base station, a distributed antenna system (DAS), etc.) based on simulating different network configurations in a virtual environment. In addition, the network coverage optimization engine can perform real-time monitoring to various network metrics to track the performance upon network configuration changes and continuously iterate on the machine learning models of the network coverage optimization engine based on the real-time monitoring and feedback associated with the network configuration changes.

In an embodiment, a network coverage optimization engine is provided. The network coverage optimization engine may comprise one or more processors and computer memory storing computer-usable instructions that, when executed by the one or more processors, cause the one or more processors to perform operations. For example, the operations may comprise receiving network data and user device network feedback. The operations may also comprise receiving location data for user devices associated with the user device network feedback. The operations may also comprise identifying a particular geographical coverage area based on the location data. The operations may also comprise determining an RF performance metric for the particular geographical coverage area is below a threshold based on the network data and the user device network feedback. The operations may also comprise determining a network configuration based on the RF performance metric being below the threshold and implementing the network configuration.

In another embodiment, a method for utilizing a network coverage optimization engine is provided. The method may comprise receiving network data and user device network feedback, and receiving location data for user devices associated with the user device network feedback. The method may comprise identifying area portions within a particular geographical coverage area based on a user device density for each of a plurality of locations from the location data within the particular geographical coverage area and based on a signal strength and interference level associated with each of the plurality of locations, the signal strength and the interference level determined from the network data and the user device network feedback. The method may comprise determining an RF performance metric for one of the area portions is below a threshold. The method may comprise determining a network configuration based on the RF performance metric being below the threshold, and implementing the network configuration.

In another example embodiment, one or more computer storage media having computer-executable instructions embodied thereon, that when executed by at least one processor, cause the at least one processor to perform a method. The method may comprise receiving network data and user device network feedback, and receiving location data for user devices associated with the user device network feedback. The method may comprise determining a user device density and a signal strength profile for each of a plurality of RF clusters within a particular geographical coverage area based on the location data, the network data, and the user device network feedback. The method may comprise determining an environmental profile for each of the plurality of RF clusters. The method may comprise determining a radio frequency (RF) performance metric for one of the plurality of RF clusters is below a threshold. The method may comprise determining a network configuration based on the RF performance metric being below the threshold and based on the environmental profile, and implementing the network configuration.

### Example Operating Environment

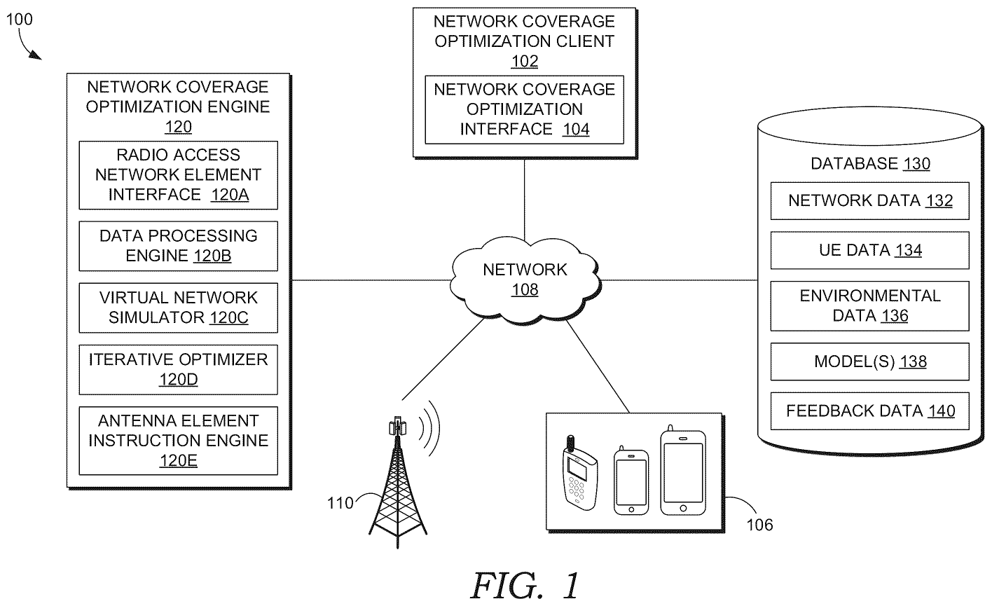

Turning now to FIG. 1, example operating environment 100 is illustrated in accordance with one or more embodiments disclosed herein. At a high level, the example operating environment 100 comprises network coverage optimization client 102 including network coverage optimization interface 104; user devices 106; network 108; base station 110; network coverage optimization engine 120 including radio access network element interface 120A, data processing engine 120B, virtual network simulator 120C, iterative optimizer 120D, and antenna element instruction engine 120E; and database 130 including network data 132, user equipment (UE) data 134, environmental data 136, model(s) 138, and feedback data 140.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional network coverage optimization clients or other configurations of the database 130 (e.g., database 130 may be a distributed computing environment encompassing multiple computing devices for storing one or more of the network data 132, user equipment (UE) data 134, environmental data 136, model(s) 138, and feedback data 140).

Network coverage optimization client 102 may be a device that has the capability of communicating (e.g., transmitting or receiving one or more signals to or from) with one or more of the base station 110, network coverage optimization engine 120, and database 130 over the network 108. In some embodiments, the network coverage optimization client 102 or one or more of the user devices 106 may be a “user device,” “computing device,” “mobile device,” “client,” “user equipment (UE),” or “wireless communication device.” In some embodiments, the network coverage optimization client 102 may be a server. The network coverage optimization client 102 or one or more of the user devices 106, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating over the network 108.

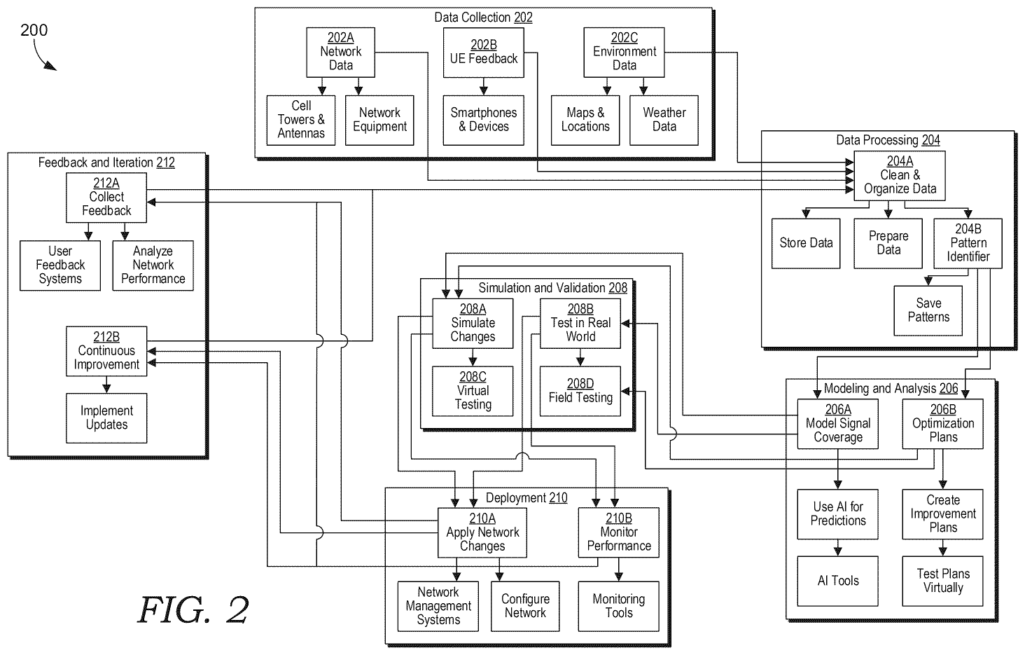

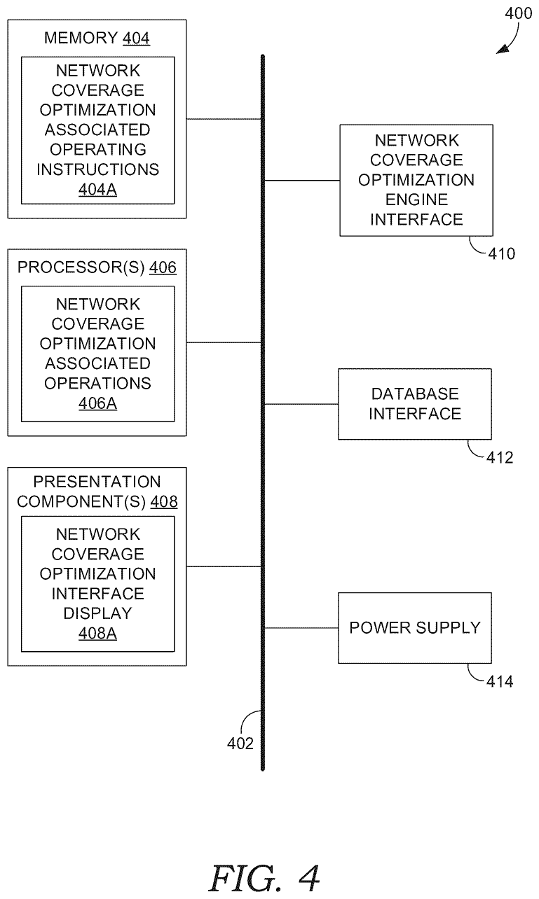

The network coverage optimization client 102 may be, in an embodiment, capable of providing the network configuration, or a portion thereof, via the network coverage optimization interface 104 or the presentation component(s) 408 of FIG. 4. In some embodiments, the network coverage optimization client 102 may be capable of providing data collection 202 (or a portion thereof), data processing 204 (or a portion thereof), modeling and analysis 206 (or a portion thereof), simulation and validation (or a portion thereof), deployment 210 (or a portion thereof), feedback and iteration 212 (or a portion thereof), of FIG. 2, etc., or one or more combinations thereof, via the network coverage optimization interface 104 or the presentation component(s) 408 of FIG. 4. In some embodiments, the network coverage optimization client 102 may be example network coverage optimization client 400 described herein with respect to FIG. 4.

In embodiments, the network coverage optimization interface 104 may be one or more presentation component(s) 408 of FIG. 4. In embodiments, the network coverage optimization interface 104 may display image data, text data, extended reality data, other types of data, or one or more combinations thereof, based on one or more operations of the network coverage optimization engine 120 (e.g., operations associated with the radio access network element interface 120A, data processing engine 120B, virtual network simulator 120C, iterative optimizer 120D, and antenna element instruction engine 120E, etc.).

In embodiments, the network 108 may include one or more of a local area network (LAN), a wide area network (WAN), a mesh network, a hybrid network, a plurality of networks, another type of network, or one or more combinations thereof. In some embodiments, one or more components (e.g., network coverage optimization client 102, base station 110, network coverage optimization engine 120, etc.) illustrated within the example operating environment 100 may communicate over the network 108 via the Internet, another public or private network, etc., or one or more combinations thereof. In some embodiments, the network 108 includes 5G standalone technology (independent of 4G technology), 5G non-standalone technology, LTE network technology, another generation network technology, 802.11x, etc., or one or more combinations thereof.

In embodiments, the base station 110 may be a macro base station, another type of outdoor base station (e.g., a micro cell, a picocell, femtocell, small cell, remote radio head), an indoor cell (e.g., a small cell or femtocell), a distributed antenna system (e.g., a network of distributed antennas connected to a central source), etc. In embodiments, the base station 110 may be a station that communicates with the user devices 106, the network coverage optimization engine 120, the network coverage optimization client 102, etc., and may, in some implementations, be an evolved node B (eNB), a next generation eNB (gNB), an access point, etc., or one or more combinations thereof. The base station 110 may provide communication coverage for a particular geographical coverage area. In 3GPP, the term “cell” can refer to a particular geographic coverage area of a base station or a base station subsystem serving the coverage area. In some embodiments, the base station 110 may be associated with a same operator or different operators, such as the example operating environment 100 may include one or more operator wireless networks. In embodiments, the base station 110 may provide communication services via one or more frequency bands in licensed spectrum, unlicensed spectrum, etc., or one or more combinations thereof.

In embodiments, the network coverage optimization engine 120 may comprise computing devices (e.g., one or more servers). In some embodiments, the network coverage optimization engine 120 may be a single server, a distributed computing environment encompassing multiple computing devices located at the same physical geographical location or at different physical geographical locations, another type of server environment, etc. In embodiments, the network coverage optimization engine 120 may comprise one or more processors, one or more electronics devices, one or more hardware devices, one or more electronics components, one or more logical circuits, one or more memories, one or more software codes, one or more firmware codes, etc., or one or more combinations thereof.

The network coverage optimization engine 120 may access the database 130 to execute tasks (e.g., associated with the radio access network element interface 120A, data processing engine 120B, virtual network simulator 120C, iterative optimizer 120D, and antenna element instruction engine 120E, etc.). For example, a user—via the network coverage optimization client 102 (e.g., via the network coverage optimization interface 104)—may transmit a request to communicate with the network coverage optimization engine 120. As another example, the network coverage optimization engine 120 may automatically configure network elements associated with base station 110, antennas of the base station 110, backhaul links, etc. In some embodiments, the network coverage optimization engine 120 may continuously analyze network data 132, UE data 134 (provided by the user devices 106), and environmental data 136 associated with the base station 110 and the network 108. The network coverage optimization engine 120 may retrieve and store the network data 132, UE data 134, and environmental data 136 from/at the database 130.

In some embodiments, the network coverage optimization engine 120 may facilitate communication(s) between different parts of the network 108 via the radio access network (RAN) element interface 120A. For example, the RAN element interface 120A may enable coordination (e.g., transfer of data) between the network 108 and one or more of the user devices 106, base station 110, database 130, network coverage optimization client 102, etc. In some embodiments, the network coverage optimization engine 120 is integrated with a network management system (NMS). In some embodiments, the RAN element interface 120A enables coordination with the network management system (NMS) to perform operations associated with the data processing engine 120B, virtual network simulator 120C, iterative optimizer 120D, antenna element instruction engine 120E, etc.

In embodiments, the network coverage optimization engine 120 may make real-time or near real-time adjustments to one or more of an electrical tilt (e.g., up tilt or down tilt) associated with an antenna of the base station 110, a power level associated with an antenna of the base station 110, a hand over parameter (e.g., a handover margin corresponding to a threshold difference in signal strength or quality between serving cell and neighboring cell, a time-to-trigger corresponding to the duration for pre-handover conditions, a handover hysteresis threshold, a signal strength threshold triggering handover, a load balancing handover parameter, etc.), another type of network configuration, or one or more combinations thereof (e.g., via the antenna element instruction engine 120E).

In embodiments, the network coverage optimization engine 120 may receive network data 132 (e.g., from database 130, base station 110, or another network component) associated with one or more geographical coverage areas, UE data 134, environmental data 136, and feedback data 140 (e.g., based on the antenna element instruction engine 120E making an alteration to a network configuration based on using model(s) 138). In embodiments, the network data 132 may include the data described as network data 202A for FIG. 2. In embodiments, UE data 134 may include the data described as UE feedback 202B for FIG. 2. In embodiments, environmental data 136 may the data described as environment data 202C for FIG. 2 discussed herein. In some embodiments, the network coverage optimization engine 120 may utilize the network data 132, UE data 134, and environmental data 136 via data collection 202 of FIG. 2 described herein.

Based on the network data 132, UE data 134, and environmental data 136, the network coverage optimization engine 120 may implement data processing engine 120B to identify one or more particular geographical coverage areas (e.g., using location data of the UE data 134 provided by the user devices 106). In some embodiments, the operations of the data processing engine 120B include data processing 204 of FIG. 2 described herein. In some embodiments, data processing engine 120B may utilize one or more central repositories storing large amounts of raw data, and an extraction, transformation, and loading pipeline.

In embodiments, the network coverage optimization engine 120 may identify area portions within a particular geographical coverage area based on a user device density for each of a plurality of locations from the location data (e.g., UE data 134) within the particular geographical coverage area and based on a signal strength an interference level associated with each of the plurality of locations, the signal strength and the interference level determined from one or more of the network data 132 and the UE data 134. In embodiments, the network coverage optimization engine 120 may identify the area portions or RF clusters based on implementing one or more model(s) 138.

For example, the model(s) 138 may include linear regression models for predicting RF signal strengths or other performance metrics based on inputs (e.g., distances from the base station 110 to the user devices 106, terrain associated with a coverage area in which the user devices 106 are located, and antenna parameters of the base station 110 antenna(s) providing coverage to the user devices 106). As another example, the model(s) 138 may include polynomial regression models for determining relationships between the inputs and RF performance metrics. In some embodiments, the model(s) 138 may include decision trees for classifying RF signal coverage quality into categories (e.g., good, fair, poor) based on inputs, random forests for RF signal quality assessment tuning, Support Vector Machines for classifying RF signal coverage based on a hyperplane that maximally separates different classes of coverage quality, K-Means clustering for identifying RF clusters of similar RF signal characteristics (e.g., similar signal strength patterns), one or more feedforward neural networks, Density-Based Spatial Clustering of Applications with Noise for clustering RF signal coverage areas based on density and outliers identified as noise, one or more Convolutional Neural Networks, one or more Recurrent Neural Networks, one or more Gradient Boosting Machines (GBM), XGBoost, LightGBM, Isolation Forests, Autoencoders, etc., or one or more combinations thereof.

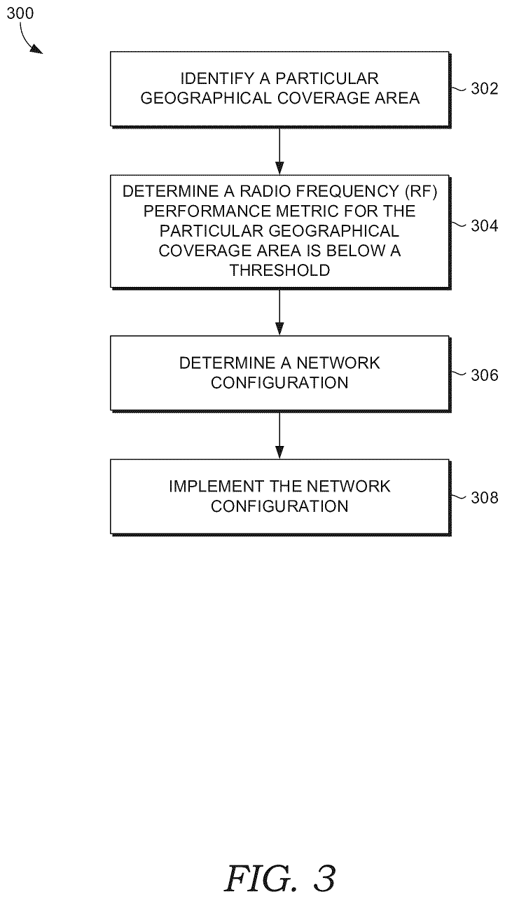

Virtual network simulator 120C may generate the simulation of a virtual network that resembles a particular network configuration for a particular set of network conditions. The virtual network simulator 120C may generate the simulation based on simulating changes 208A described herein with respect to FIG. 2. The virtual network simulator 120C may generate the simulation based on the operations discussed herein with step 306 of FIG. 3. In addition, the iterative optimizer 120D may perform operations based on feedback and iteration 212 of FIG. 2 discussed herein. As another example, the iterative optimizer 120D may perform operations based on step 308 of FIG. 3 discussed herein. The antenna element instruction engine 120E may make one or more alterations to a network configuration via operations of step 308 of FIG. 3 discussed herein. The antenna element instruction engine 120E may make one or more alterations to a network configuration based on the feedback and iteration 212 of FIG. 2. The antenna element instruction engine 120E may make one or more alterations to a network configuration based on data processing engine 120B, virtual network simulator 120C, and iterative optimizer 120D.

### Example Flowcharts

Having described the example embodiments discussed above, an example flowchart 200 is described below with respect to FIG. 2. Example flowchart 200 begins with data collection 202. The data collection 202 may include receiving (or retrieving from database 130 of FIG. 1) network data 202A (e.g., network data 132 of FIG. 1), UE feedback 202B (e.g., UE data 134 of FIG. 1), and environment data 202C (e.g., environmental data 136 of FIG. 1).

For example, the network data 202A may include cell tower and antenna data (e.g., base station geographic coordinates, base station altitude, cell identifier, cell tower location area code identifier, mobile network code, network operator identifier, tower height, sector identifier, backhaul identifier, antenna identifier (e.g., indicating omni-directional, sector, panel, Yagi, etc.), azimuth angle, physical tilt identifier, electrical tilt angle identifier, frequency band range, channel bandwidth, antenna amplification, beamwidth, radiation pattern, power output level, standing wave ratio, antenna geographic area coverage, handover success rate, handover latency, interference data, a number of user devices utilizing a frequency band, throughput, etc., or one or more combinations thereof. The network data 202A may be received from base stations and their associated antennas, other types of network equipment (e.g., Mobile Switching Center, Gateway General Packet Radio Service (GPRS) Support Node, Serving GPRS Support Node, Serving Gateway, Packet Data Network Gateway, Network Management System, Element Management System, Wi-Fi access points, servers, load balancers, Storage Area Networks), etc.

As another example, the UE feedback 202B may include measured Reference Signal Received Power (RSRP), Reference Signal Received Quality (RSRQ), Signal to Interference plus Noise Ratio (SINR), Received Signal Strength Indicator (RSSI), a Channel Quality Indicator, Energy per Chip to Interference and Noise Ratio, Received Signal Strength, Pilot Channel Interference, etc., or one or more combinations thereof. In embodiments, the UE feedback 202B may also include location data, such as GPS coordinates, Round Trip Time, Angle of Arrival, Observed Time Difference of Arrival, a cell identifier of a base station that the user device is connected to, an enhanced cell identifier, Timing Advance, Bluetooth beacon identifiers and signal strength, Wi-Fi Positioning Data, etc., or one or more combinations thereof. The UE feedback 202B may be received from user devices (e.g., smartphones and other devices).

The environmental data 136 may include weather data, such as temperature, humidity, precipitation, wind speed and direction, barometric pressure, etc. The environmental data 136 may include terrain data, such as elevation, topography, vegetation, obstructions, etc. In embodiments, the environmental data 136 may be received using one or more weather sensors located throughout a coverage area, satellite data systems, weather application programming interfaces, geographic information systems, light detection and ranging systems, satellite imagery systems, digital elevation models, environmental applications, weather data systems, map and location systems, etc.

Each of the network data 202A, UE feedback 202B, and environment data 202C may be transmitted for data processing 204 (e.g., corresponding to data processing engine 120B of FIG. 1). For example, the network data 202A, UE feedback 202B, and environment data 202C may be cleaned (e.g., preprocessed, missing values management, duplicate removal, error corrections) and organized (e.g., normalize, standardize, conversion of categorical variables into numerical formats, feature engineering to create new relevant features, data splitting) at step 204A of the data processing 204. During data processing 204 and after step 204A, the network data 202A, UE feedback 202B, and environment data 202C may be stored, prepared (e.g., feature extraction, transformations, load processes for data handling), or both, so that pattern identifier 204B for pattern identification.

For example, K-Means clustering may be applied to identify clusters that have similar RF signal characteristics (e.g., coverage areas with similar signal strength patterns). Additionally or alternatively, one or more Convolutional Neural Networks may be applied to analyze RF signal data in spatial patterns (e.g., for image-based RF signal analysis using a signal strength map). In some embodiments, the patterns may be identified using linear regression for RF signal strength patterns or other performance metrics patterns based on inputs such as user device distances from the base station, terrain associated with user device locations, and antenna parameters of the antenna providing a frequency band to the user device. In some embodiments, a decision tree may be used to classify RF signal coverage quality for pattern identification (e.g., good, fair, poor) based on the inputs. Each of the identified patterns may be stored.

Based on the patterns identified, modeling and analysis 206 may be applied. For example, the data processed by pattern identifier 204B may be provided to modeling and analysis 206 for model signal coverage 206A and optimization plans 206B. Model signal coverage 206A may generate predictions using artificial intelligence and artificial intelligence tools (e.g., to generate a model signal coverage map). In embodiments, the model signal coverage 206A may include implementing one or more machine learning models to predict a signal strength and coverage based on an alteration to a network configuration. In some embodiments, ensemble models may be used for development of the particular artificial intelligence and artificial intelligence tools based on combining multiple individual models for predictions. The ensemble models may include one or more Gradient Boosting Machines (e.g., decision tree combinations) for RF optimization task predictions, and XGBoost and LightGBM for RF optimization tasks associated with the network configuration predictions.

The optimization plans 206B may include creating improvement plans to a current network configuration and testing of those improvement plans virtually. By way of example, the improvement plans to the current network configuration may include one or more electrical tilt alterations (e.g., a down tilt change to a current network configuration), one or more antenna power level alterations (e.g., increasing the antenna power for a particular antenna associated with a particular pattern identified), one or more hand over parameter alterations associated with a current network configuration corresponding to a particular pattern identified, etc. In an embodiment, first improvement plan may include a first electrical tilt alteration and a first power level alteration, and a second improvement plan may include a second electrical tilt alteration and a second power level alteration.

The model signal coverage 206A may be provided to simulation and validation 208 for simulating changes 208A and testing in the real world 208B. The optimization plans 206B may be provided to simulation and validation 208 for simulating changes 208A and field testing 208D. Virtual testing 208C may correspond to virtual network simulator 120C of FIG. 1. In embodiments, simulating changes 208A may include the implementation of a virtual network environment associated with particular software instructions for the simulation of a virtual network that resembles a particular network configuration for a particular set of network conditions. The virtual network environment can include simulated terrain elevation, vegetation, weather patterns, obstructions, etc., associated with a particular geographical coverage area. The virtual network environment can include simulated frequency band transmissions to user devices in particular locations within a particular geographical coverage area.

In some embodiments, modeling and analysis 206 and simulation and validation 208 correspond to virtual network simulator 120C of FIG. 1.

The simulation and validation 208 may be provided for deployment 210 including application of network changes 210A and monitoring of network performance 210B. Monitoring tools for the monitoring of network performance 210B may include real-time network monitoring via Simple Network Management Protocol or another protocol for monitoring of routers, switches, and servers, tools for monitoring applications and cloud services, tools for monitoring network services (Simple Mail Transfer Protocol, Post Office Protocol, Hypertext Transfer Protocol, Network News Transfer Protocol, Internet Control Message Protocol, Simple Network Management Protocol, etc.), host resources (processor load, disk usage, system logs), etc. The application of network changes 210A may include network management systems (e.g., associated with RAN element interface 120A of FIG. 1) and configuration of the network (e.g., implementation of a network configuration alteration via the antenna element instruction engine 120E of FIG. 1).

Based on deployment 210, feedback and iteration 212 may include the collection of feedback 212A (e.g., feedback data 140 of FIG. 1) based on user device feedback systems and analysis of the network performance after the deployment 210. Continuous improvement 212B (e.g., of the models associated with data processing 204, modeling and analysis 206, simulation and validation 208; of the models 138 of FIG. 1) may be implemented based on the feedback 212A (e.g., additional location data for user devices, additional network data, additional user device network feedback, additional environmental data). The continuous improvement 212B may be used for implementing updates (e.g., updated RF performance metrics for a network configuration, updated models, updated training data for the models, regenerating virtual environments of the simulated network configuration for each of a plurality of network configuration alterations, re-identifying particular virtual environments having a particular number of updated RF performance metrics that are above a threshold).

FIG. 3 includes flowchart 300, which begins at step 302 with identifying a particular geographical coverage area. In embodiments, the particular geographical coverage area may be identified based on receiving location data of a plurality of user devices located within the particular geographical coverage area. In some embodiments, the location data includes geographical positions of user devices connected to the base station. In embodiments, the location data may include GPS coordinates, cell identifiers and timing advance values associated with a distance from the base station, a received signal strength indicator (RSSI), a reference signal received power (RSRP), a signal-to-Interference-plus-Noise Ratio (SINR), etc., or one or more combinations thereof. In embodiments, the location data may be UE data 134 of FIG. 1.

At step 304, an RF performance metric is for the particular geographical coverage area is determined as being below a threshold. In embodiments, the RF performance metric may be determined as being below the threshold based on receiving network data (e.g., network data 132 of FIG. 1) and user device network feedback (e.g., UE data 134 of FIG. 1). In embodiments, the RF performance metric may be determined as being below the threshold based on data collection 202 and data processing 204 of FIG. 2. In some embodiments, an RF performance metric may be determined for one or more area portions (e.g., RF clusters) within the particular geographical coverage area (e.g., for a subsequent determination as to whether that metric is above or below a particular threshold).

In embodiments, the RF performance metric (e.g., a key performance indicator (KPI)) may be an RSSI, an RSRP, a reference signal received quality (RSRQ), a Signal-to-Noise Ratio (SNR), SINR, a Carrier-to-Interference Ratio, an Error Vector Magnitude (EVM) associated with the difference between an expected and actual received signal, a Block Error Rate (BLER), a Bit Error Rate (BER), a latency measurement associated with a time delay between transmission and reception of a signal, a throughput measuring the rate of a successful data transmission over the network, jitter measuring packet arrival time variability, etc., or one or more combinations thereof.

In some embodiments, a RF performance metric may be determined by applying a linear regression model to identify linear relationships or a polynomial regression model to identify nonlinear relationships associated with distances between the base station providing telecommunication services for the particular geographical coverage area and the user devices within the particular geographical area, linear or nonlinear relationships associated with one or more terrain portions within the particular geographical coverage area (e.g., the terrain data being derived or received from Geographical Information System (GIS) Data, satellite imagery and remote sensing, digital evaluation model(s), light detection and ranging data, an online terrain data service, crowdsourced data, etc.), linear or nonlinear relationships associated with antenna parameter(s) (e.g., frequency range or bandwidth, antenna gain, beamwidth, vertical polarization, horizontal polarization, circular polarization, azimuth, elevation angle, voltage standing wave ratio, impedance, front-to-back ratio, antenna height, electrical and mechanical tilt, radiation pattern, power handling capacity, isolation associated with other antennas, etc.) of the base station for the particular geographical coverage area, etc., or one or more combinations thereof.

In embodiments, clusters within the particular geographical area may be identified. As an example, based on identifying the linear and nonlinear relationships via the regression model(s), the clusters within the particular geographical coverage area may be identified, using a clustering algorithm (e.g., k-means clustering, hierarchical clustering, Density-Based Spatial Clustering of Applications with Noise (DBSCAN), mean shift clustering, Gaussian Mixture Models (GMM), agglomerative clustering, spectral clustering, Balanced Iterative Reducing and Clustering using Hierarchies (BIRCH), etc.). In embodiments, clusters that have similar signal strength patterns (e.g., radial pattern that decreases uniformly as the distance from the base station increases, sectorized pattern with stronger signals within each sector and weaker signals at the sector edge, urban coverage patter, rural coverage pattern, indoor coverage pattern, a shadowing and fading pattern, cell edge pattern, etc.) may be identified.

In embodiments, RF clusters within the particular geographical coverage area may be identified using DBSCAN based on user device densities (e.g., associated with the location data for the user devices) within the particular geographical coverage area and based on identifying location data outliers as noise. For example, the user device densities may refer to the number of user devices within a specific area. In some embodiments, the user device densities may correspond to one or more of a peak time, an off-peak time, a densely populated area, a less densely populated area, a residential area, a business district, etc., or one or more combinations thereof.

In some embodiments, additionally or alternatively, the RF clusters within the particular geographical coverage area may be identified using DBSCAN based on RF signal coverage densities (e.g., associated with the network data and the user device network feedback) within the particular geographical coverage area and based on identifying RF signal measurement outliers as noise. For example, the RF signal coverage densities may refer to the distribution and intensity of RF signals within a specific area. In some embodiments, the RF signal coverage densities may correspond to one or more of a transmit power associated with a base station antenna, a type and configuration of the antenna, a frequency band provided by the antenna, a load associated with the antenna, a uniform RF signal coverage density for a first specific area, a higher RF signal coverage density for a second specific area, a sparse RF signal coverage density for a third specific area, a gradient RF signal coverage density for a fourth specific area, etc., or one or more combinations thereof.

In some embodiments, the RF clusters may be identified by applying DBSCAN to user device mobility patterns and peak usage times. For example, the RF clusters may be identified based on the detection of user device mobility pattern outliers as noise and detection of peak usage time outliers as noise. As another example, the user device mobility patterns and peak usage times may be determined by applying a recurrent neural network (e.g., Long Short-Term Memory (LSTM), Gated Recurrent Unit (GRU), Bidirectional Recurrent Neural Network (BiRNN), RNN with Attention, a deep RNN, a hierarchical RNN, etc.) to the location data, the network data, and the user device network feedback. For instance, handover data, Wi-Fi connection establishment data, signal strengths from Wi-Fi networks, GPS data, crowdsourced application location data, base station triangulation data, etc., for a particular set of user devices during a particular time period, may be provided to the RNN to determine user device mobility patterns and peak usage times. In some embodiments, an RF signal coverage density for each of the RF clusters within the particular geographical coverage area may be identified by applying DBSCAN to the user device mobility patterns and the peak usage times.

In some embodiments, area portions within the particular geographical coverage area may be classified by applying a Support Vector Machine (SVM) to the location data, the network data, and the user device network feedback. For example, the area portions may be classified based on RF signal coverage a hyperplane (e.g., a decision boundary separating different classes of data points within the location data, the network data, and the user device network feedback) that maximally separates different area portions of coverage quality within the particular geographical coverage area. For example, the SVM may be used to maximize a margin between two area portions based on signal strength and coverage quality to create a maximum distance between the hyperplane and the nearest data points from each of the two area portions.

In some embodiments, area portions within a particular geographical coverage area may be identified based on a user device density for each of a plurality of locations from the location data within the particular geographical coverage area and based on a signal strength and interference level associated with each of the plurality of locations, the signal strength and the interference level determined from the network data and the user device network feedback. Additionally or alternatively, in some embodiments, the area portions may be identified by applying a convolutional neural network (e.g., a residual network, a fully convolutional network, a densely connected network, a capsule network, a deformable convolutional network, a recurrent convolutional neural network, a multiscale convolutional network, etc.) to a signal strength map for the particular geographical coverage area to identify spatial patterns within the signal strength map that correspond to each of the area portions.

For example, the signal strength map may be generated using geotagged signal strength measurements at various locations within one or more sectors of the particular geographical coverage area, user device application signal strength measurements, fixed monitoring stations located within a cell sector, Network Management System (NMS) collected data, etc., or one or more combinations thereof. As another example, the signal strength map may be generated by applying a recurrent neural network (or another type of neural network) to sequential RF signal data, from the network data and the user device network feedback, over time. For example, the signal strength map data points from using the recurrent neural network may have environmental data overlaid to provide additional contextual features to the signal strength map.

In some embodiments, a user device density and a signal strength profile may be determined for each of a plurality of RF clusters within the particular geographical coverage area based on the location data, the network data, and the user device network feedback, and an environmental profile may be determined, identified, or generated for each of the plurality of RF clusters. For example, the signal strength profile may identify the variation of signal strength across an RF cluster. In embodiments, the signal strength profile may be represented by text, computer-readable code, a heat map, a contour map, a 3D surface plot, etc. In some embodiments, the signal strength profile may differentiate the different levels of signal strength within an RF cluster using a specific range of signal strength values (e.g., measured in dBm).

As another example, user device densities for the RF clusters may indicate the variation among the number of user devices within each RF cluster. In some embodiments, user device densities may include change indicators associated with a rate of user density change and a frequency of that change. In embodiments, the environment profile may include physical terrain features, weather patterns, and other geographic features (e.g., obstructions that would affect signal propagation) within each RF cluster. For example, the environment profile may include elevation and altitude identifiers, water identifiers (e.g., a lake), road identifiers, landmark identifiers, vegetation density and type, agricultural area indicators, building size and location indicators, residential area indicators, rainfall indicators, temperature indicators, humidity indicators, etc., or one or more combinations thereof.

In some embodiments, an RF performance metric for an RF cluster may be determined as being below the threshold based on applying an SVM to the signal strength profile for each of the plurality of RF clusters. In some embodiments, the user device density, for each of a plurality of RF clusters within the particular geographical coverage area, may be determined by applying DBSCAN to the location data and the user device network feedback and based on identifying location data outliers and user device network feedback outliers as noise.

At step 306, a network configuration is determined based on an RF performance metric being below a threshold. For example, the network configuration may be determined for an RF cluster or an area portion within the particular geographical coverage area. In some embodiments, the RF performance metric is a signal strength RF performance metric that is below the threshold.

In some embodiments, the network configuration may be determined using an isolation forest to identify an interference source corresponding to the RF performance metric that is below the threshold. The isolation forest may be used based on random selection(s) of a particular RF performance metric and a subsequent random selection of a split value between a minimum and a maximum value for that particular RF performance metric, and identifying the area portion within the particular geographical coverage area having RF performance metric that is below the threshold based on the path length of a split being below a threshold. As another example, network configuration may be determined using one or more autoencoders including unsupervised learning model(s) that learn data representations associated with RF performance metrics of various RF clusters to identify deviations from a normal, standard, or predicted RF signal behavior.

In some embodiments, the network configuration is determined based on predicting, using a feedforward neural network (e.g., a multi-layer perceptron, a deep neural network, a radial basis function network, a modular neural network, another type of artificial neural network having connections between nodes without forming cycles), a plurality of RF performance metrics (e.g., signal strength RF performance metrics) for each of a plurality of network configuration alterations (e.g., alterations to the current network configuration for the RF cluster or area portion identified has having the RF performance metric below the threshold) based on using multiple layers of interconnected neurons of the feedforward neural network. For example, the multiple layers of interconnected neurons of the feedforward neural network can be used to predict a KPI (e.g., an RSSI, an RSRP, an RSRQ, SNR, SINR, a Carrier-to-Interference Ratio, EVM, BLER, BER, a latency measurement associated with a time delay between transmission and reception of a signal, a throughput measuring the rate of a successful data transmission over the network, jitter measuring packet arrival time variability, etc., or one or more combinations thereof) based on a particular alteration (e.g., one or more electrical tilt alterations, one or more antenna power level alterations, one or more hand over parameters associated with a current network configuration for an RF cluster).

In embodiments, a plurality of RF performance metrics may be predicted for each of a plurality of network configuration alterations to a current network configuration of a particular RF cluster by applying a path loss algorithm and a ray tracing algorithm to the network data and the user device network feedback for that RF cluster. In embodiments, the path loss algorithm may determine attenuation of signal strength (e.g., attenuation with no obstacles determined using an environmental profile, attenuation based on a height of the base station antenna and position of user device antenna(s), attenuation with various obstacles determined using an environmental profile, attenuation based on a combined effect of a rooftop and building wall, attenuation based on a combined effect of weather patterns and terrain, etc.) as it propagates from a transmitter to a receiver for various network configuration alterations that change one or more parameters of a current network configuration. In embodiments, the ray tracing algorithm may model RF propagation through an environment to simulate ray pathways (e.g., the wave front of the signal) during transmission, reflections, refractions, and diffractions.

As another example, the network configuration may be determined based on RF signal strength predictions for a particular RF cluster upon implementation of a change to a current network configuration based on a distance of the particular RF cluster (e.g., the distance being measured to the furthest point of the RF cluster from the base station, the distance being measured to a central point of the RF cluster) from a base station or an antenna of the base station associated with the current network configuration, a terrain of the particular RF cluster from its environmental profile, and antenna parameters of the base station, etc., or one or more combinations thereof.

In some embodiments, predictions (e.g., using the feedforward neural network) may be determined using the virtual network simulator 120C of FIG. 1, the iterative optimizer 120D of FIG. 1, etc., or one or more combinations thereof. As an example, a virtual environment of a simulated network configuration for each of a plurality of network configuration alterations for the particular RF cluster (or a particular area portion) may be generated (e.g., using the virtual network simulator 120C of FIG. 1) using the plurality of RF performance metrics predicted based on the alterations (that have not yet been implemented) for assessment of the impact(s) of change(s) on RF coverage and quality of service metrics. For example, the virtual environments may be validated by using actual field measurements and adjusted based on the actual field measurements. As another example, the virtual environment of the simulated network configuration may be generated using block diagram modeling, domain libraries, real-time simulation, hardware-in-the-loop (HIL) testing, etc., or one or more combinations thereof. To illustrate, the virtual environment for a first antenna parameter network configuration adjustment may be generated using the location data from the user devices, historical RF parameter metrics from a prior network configuration using that antenna parameter, extended reality software to provide the virtual computer-generated environment, etc.

In some embodiments, a convolutional neural network may be applied to identify a virtual environment having a greatest number of RF performance metrics that are above the threshold for implementation of the particular network configuration. For example, a first virtual environment for a first antenna parameter network configuration adjustment (e.g., an adjustment to an electrical tilt) may have the greatest number of RF performance metrics compared to other virtual environments generated for other antenna parameter adjustments. As another example, a first virtual environment for a first hand over parameter network configuration adjustment (e.g., a reduction to a signal strength threshold triggering handover) may have the greatest number of RF performance metrics compared to other virtual environments generated for other hand over parameter adjustments (e.g., increases to a signal strength threshold triggering handover).

At step 308, the network configuration identified is implemented. For example, the network configuration may have a different electrical tilt, power level, hand over parameter, etc., or one or more combinations thereof, associated with a current network configuration for the area portion within the particular geographical coverage area that has the RF performance metric below the threshold.

In some embodiments, based on implementing the network configuration, additional location data, additional network data, additional user device network feedback (e.g., for a portion of the particular geographical coverage area corresponding to an area portion for which the network configuration was implemented), additional environmental data, etc., may be continuously received. Based on continuously receiving this additional data, one or more of the AI models (e.g., a recurrent neural network, a DBSCAN, a convolutional neural network, etc.) may be continuously iterated (e.g., continuous learning or model retraining). For example, the continuous iteration may include preprocessing of the additional data (e.g., cleaning, filtering, de-duplicating, normalizing, standardizing, transforming, missing value predicting, scaling, encoding categorical variables, etc.), detecting data distribution changes from the previous data distributions, hyper-parameter optimization, retraining, feedback loop implementation, etc., or one or more combinations thereof.

Based on the continuous iterating, a virtual environment, of the simulated network configuration for each of the plurality of network configuration alterations, may be regenerated using updated RF performance metrics (e.g., updated based on the additional location data, the additional network data, the additional user device network feedback, the additional environmental data, etc.). In this way, a virtual environment having the greatest number of the updated RF performance metrics that are above the threshold can be re-identified based on the virtual environment regenerating. For example, other network configuration alterations can be implemented based on the continuous iterating and the virtual environment regenerating.

### Example Network Coverage Optimization Client

Referring now to FIG. 4, a diagram is depicted of an example network coverage optimization client suitable for use in implementations of the present disclosure. In particular, the example network coverage optimization client is shown and designated generally as network coverage optimization client 400. Example network coverage optimization client 400 is but one example of a suitable computing environment and is not intended to suggest any limitation as to the scope of use or functionality of the invention. Neither should network coverage optimization client 400 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, network coverage optimization client 400 includes bus 402 that directly or indirectly couples the following devices: memory 404, one or more processors 406, one or more presentation components 408, network coverage optimization engine interface 410, database interface 412, and power supply 414. The memory 404 may include network coverage optimization associated operating instructions 404A, which may be executed by the processor(s) 406 to perform network coverage optimization associated operations 406A. The one or more presentation components 408 may include network coverage optimization interface display 408A.

Although the components of FIG. 4 are shown with lines for the sake of clarity, in reality, delineating various components is not so clear, and metaphorically, the lines would more accurately be grey and fuzzy. For example, processors, such as one or more processors 406, have memory. The present disclosure hereof recognizes that such is the nature of the art, and reiterates that FIG. 4 is merely illustrative of an example network coverage optimization client 400 that may be used in connection with one or more implementations of the present disclosure.

In some embodiments, the network coverage optimization client 400 may be a “workstation,” “server,” “laptop,” “handheld device,” “computing device,” etc. In some embodiments, the network coverage optimization client 400 may be network coverage optimization client 102 of FIG. 1.

In some embodiments, bus 402 may represent what may be one or more busses (such as an address bus, data bus, or combination thereof).

The network coverage optimization client 400 may include a variety of computer-readable media. Computer-readable media may be any available media that may be accessed by network coverage optimization client 400 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 404 includes computer-storage media in the form of volatile and/or nonvolatile memory. Memory 404 may be removable, non-removable, or a combination thereof. Examples of memory 404 may include solid-state memory, hard drives, optical-disc drives, etc., or one or more combinations thereof.

Example network coverage optimization client 400 also includes one or more processors 406 that read data from one or more entities, such as bus 402, memory 404, one or more presentation components 408, network coverage optimization engine interface 410, database interface 412, or power supply 414. Examples of one or more processors 406 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors, or one or more combinations thereof.

The processor(s) 406 may perform network coverage optimization associated operations 406A, which may include receiving one or more portions of a network configuration, receiving one or more portions of a network configuration to be implemented, transmitting user device network feedback, transmitting location data of the network coverage optimization client 400, performing operations based on a received network configuration, etc., or one or more combinations thereof.

One or more presentation components 408 may present (e.g., to a person or other device) data indications. Examples of the one or more presentation components 408 may include a display device, speaker, printing component, vibrating component, etc. In an embodiment, network coverage optimization engine interface 410 may allow network coverage optimization client 400 to be communicatively coupled to network coverage optimization engine 120 of FIG. 1 or other devices. In some embodiments, network coverage optimization engine interface 410 may be network coverage optimization interface 104 of FIG. 1. In some embodiments, the one or more presentation components 408 may present data received via the network coverage optimization engine interface 410 or the database interface 412. In some embodiments, the database interface 412 may allow network coverage optimization client 400 to be communicatively coupled to database 130 of FIG. 1. For example, the database 130 of FIG. 1 may receive user device network feedback, location data, etc., or one or more combinations thereof, from the network coverage optimization client 400. In some embodiments, the network coverage optimization client 400 may retrieve data from the database 130 of FIG. 1.

In embodiments, the network coverage optimization client 400 facilitates communication with a wireless telecommunications network (e.g., via a radio). Illustrative wireless telecommunications technologies may include CDMA, GPRS, TDMA, GSM, and the like. The network coverage optimization client 400 might additionally or alternatively facilitate other types of wireless communications including Wi-Fi, WiMAX, LTE, or other VoIP communications. As can be appreciated, in various embodiments, network coverage optimization client 400 may be configured to support multiple technologies and/or multiple radios may be utilized to support multiple technologies.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A network coverage optimization engine comprising:
one or more processors; and
computer memory storing computer-usable instructions that, when executed by the one or more processors, cause the one or more processors to perform operations comprising:
receiving network data and user device network feedback;
receiving location data for user devices associated with the user device network feedback;
identifying a particular geographical coverage area based on the location data;
determining a radio frequency (RF) performance metric for the particular geographical coverage area is below a threshold based on the network data and the user device network feedback;
determining a network configuration based on the RF performance metric being below the threshold; and
implementing the network configuration.

2. The network coverage optimization engine according to claim 1, the operations further comprising:
determining the RF performance metric by applying a polynomial regression model to identify nonlinear relationships among distances between a base station providing telecommunication services to the particular geographical coverage area and the user devices, a terrain of the particular geographical coverage area, and antenna parameters of the base station, for the particular geographical coverage area;
based on identifying the nonlinear relationships, identifying clusters, using a clustering algorithm, within the particular geographical coverage area that have similar signal strength patterns;
determining one of the clusters identified has a signal strength below a threshold; and
implementing the network configuration by alternating a hand over parameter for the one of the clusters identified.

3. The network coverage optimization engine according to claim 1, the operations further comprising:
identifying RF clusters within the particular geographical coverage area using Density-Based Spatial Clustering of Applications with Noise (DBSCAN) based on:
user device densities, associated with the location data for the user devices, within the particular geographical coverage area and based on identifying location data outliers as noise; and
RF signal coverage densities, associated with the network data and the user device network feedback, within the particular geographical coverage area and based on identifying RF signal measurement outliers as noise; and
determining one of the RF clusters identified has a signal strength RF performance metric below the threshold.

4. The network coverage optimization engine according to claim 3, the operations further comprising:
predicting, using a feedforward neural network, a plurality of signal strength RF performance metrics for each of a plurality of network configuration alterations based on using multiple layers of interconnected neurons of the feedforward neural network;
identifying one of the plurality of signal strength RF performance metrics that is above a signal strength RF performance metric threshold; and
implementing the network configuration that corresponds to a network configuration alteration, of the plurality of network configuration alterations, that corresponds to the one of the plurality of signal strength RF performance metrics.

5. The network coverage optimization engine according to claim 1, the operations further comprising:
determining user device mobility patterns and peak usage times by applying a recurrent neural network to the location data, the network data, and the user device network feedback;
identifying RF clusters and an RF signal coverage density for each of the RF clusters within the particular geographical coverage area by applying Density-Based Spatial Clustering of Applications with Noise (DBSCAN) to the user device mobility patterns and the peak usage times;
determining one of the RF clusters identified has a signal strength RF performance metric below the threshold;
determining the network configuration for the one of the RF clusters; and
implementing the network configuration for the one of the RF clusters.

6. The network coverage optimization engine according to claim 5, the network configuration for the one of the RF clusters being determined by:
predicting a plurality of RF performance metrics for each of a plurality of network configuration alterations to a current network configuration of the one of the RF clusters by applying a path loss algorithm and a ray tracing algorithm to the network data and the user device network feedback for the one of the RF clusters;
generating a virtual environment of a simulated network configuration for each of the plurality of network configuration alterations using the plurality of RF performance metrics predicted; and
identifying, by applying a convolutional neural network, the virtual environment having a greatest number of the plurality of RF performance metrics that are above the threshold.

7. The network coverage optimization engine according to claim 6, the operations further comprising:
based on implementing the network configuration for the one of the RF clusters, continuously receiving additional location data, additional network data, and additional user device network feedback for a portion of the particular geographical coverage area corresponding to the one of the RF clusters; and
continuously iterating the recurrent neural network, the DBSCAN, and the convolutional neural network based on the additional location data, the additional network data, and the additional user device network feedback.

8. The network coverage optimization engine according to claim 7, further comprising:
based on the continuous iterating, regenerating the virtual environment of the simulated network configuration for each of the plurality of network configuration alterations using updated RF performance metrics from the additional location data, the additional network data, and the additional user device network feedback; and
re-identifying the virtual environment having the greatest number of the updated RF performance metrics that are above the threshold based on the regenerating.

9. The network coverage optimization engine according to claim 1, the operations further comprising:
classifying area portions within the particular geographical coverage area by applying a Support Vector Machine (SVM) to the location data, the network data, and the user device network feedback, the area portions classified based on RF signal coverage a hyperplane that maximally separates different area portions of coverage quality;
determining the RF performance metric of one of the area portions within the particular geographical coverage area is below the threshold;
determining the network configuration for the one of the area portions based on predicting, using a feedforward neural network, a plurality of RF performance metrics for each of a plurality of network configuration alterations based on using multiple layers of interconnected neurons of the feedforward neural network; and
based on using the feedforward neural network, implementing the network configuration for the one of the area portions.

10. A method for utilizing a network coverage optimization engine, the method comprising:
receiving network data and user device network feedback;
receiving location data for user devices associated with the user device network feedback;
identifying area portions within a particular geographical coverage area based on a user device density for each of a plurality of locations from the location data within the particular geographical coverage area and based on a signal strength and interference level associated with each of the plurality of locations, the signal strength and the interference level determined from the network data and the user device network feedback;
determining a radio frequency (RF) performance metric for one of the area portions is below a threshold;
determining a network configuration based on the RF performance metric being below the threshold; and
implementing the network configuration.

11. The method according to claim 10, the area portions being identified by applying a convolutional neural network to a signal strength map for the particular geographical coverage area to identify spatial patterns within the signal strength map that correspond to each of the area portions.

12. The method according to claim 11, the signal strength map being generated by applying a recurrent neural network to sequential RF signal data, from the network data and the user device network feedback, over time.

13. The method according to claim 12, the determining a network configuration being determined using an isolation forest to identify an interference source corresponding to the RF performance metric that is below the threshold.

14. The method according to claim 13, the network configuration having a different electrical tilt, power level, and hand over parameter associated with a current network configuration for the one of the area portions.

15. One or more computer storage media having computer-executable instructions embodied thereon, that when executed by at least one processor, cause the at least one processor to perform a method comprising:
receiving network data and user device network feedback;
receiving location data for user devices associated with the user device network feedback;
determining a user device density and a signal strength profile for each of a plurality of RF clusters within a particular geographical coverage area based on the location data, the network data, and the user device network feedback;
determining an environmental profile for each of the plurality of RF clusters;
determining a radio frequency (RF) performance metric for one of the plurality of RF clusters is below a threshold;
determining a network configuration based on the RF performance metric being below the threshold and based on the environmental profile; and
implementing the network configuration.

16. The one or more computer storage media of claim 15, the network configuration being determined based on RF signal strength predictions for the one of the plurality of RF clusters upon implementation of a change to a current network configuration based on a distance of the one of the plurality of RF clusters from a base station associated with the current network configuration, a terrain of the one of the plurality of RF clusters from the environmental profile, and antenna parameters of the base station.

17. The one or more computer storage media of claim 15, the RF performance metric for one of the plurality of RF clusters determined as being below the threshold by applying a Support Vector Machine (SVM) to the signal strength profile for each of the plurality of RF clusters.

18. The one or more computer storage media of claim 17, the user device density, for each of the plurality of RF clusters within the particular geographical coverage area, being determined by applying Density-Based Spatial Clustering of Applications with Noise (DBSCAN) to the location data and the user device network feedback and based on identifying location data outliers and user device network feedback outliers as noise.

19. The one or more computer storage media of claim 15, further comprising:
predicting a plurality of RF performance metrics for each of a plurality of network configuration alterations to a current network configuration of the one of the plurality of RF clusters having the RF performance metric below the threshold;
generating a virtual environment of a simulated network configuration for each of the plurality of network configuration alterations using the plurality of RF performance metrics predicted; and
determining the network configuration to be implemented based on identifying the virtual environment having a greatest number of the plurality of RF performance metrics that are above the threshold.

20. The one or more computer storage media of claim 19, the plurality of RF performance metrics being predicted using multiple layers of interconnected neurons of a feedforward neural network.
